(19) United States
(12) Patent Application Publication
(10) Pub. No.: US 2019/0131823 A1
(43) Pub. Date: May 2, 2019

(54) WIRELESS POWER RECEIVING APPARATUS CONTROLLING OUTPUT VOLTAGE

(71) Applicant: Electronics and Telecommunications Research Institute, Daejeon (KR)

(72) Inventors: Dukju AHN, Incheon (KR); Sang-Won KIM, Daejeon (KR); Seong-Min KIM, Daejeon (KR); Jung Ick MOON, Daejeon (KR); In Kui CHO, Daejeon (KR)

(73) Assignee: Electronics and Telecommunications Research Institute, Daejeon (KR)

(21) Appl. No.: 15/986,463

(22) Filed: May 22, 2018

(30) Foreign Application Priority Data
Oct. 31, 2017 (KR) 10-2017-0144236

(51) Int. Cl. H02J 50/12; H02M 7/217

(52) U.S. Cl. CPC H02J 50/12; H02J 7/025; H02M 7/217

(57) ABSTRACT

Disclosed is a wireless power receiving apparatus controlling an output voltage. The wireless power receiving apparatus may include a first rectifier to which a first coil receiving power from a wireless power transmitting apparatus and a first capacitor are connected, a second rectifier to which a second coil receiving power from the wireless power transmitting apparatus and a second capacitor are connected, a first switch connected to one end of the first rectifier, and a second switch and a third switch connected to both ends of the second rectifier, in which the first rectifier and the second rectifier are connected in parallel, and an operation mode of the wireless power receiving apparatus may be determined based on whether the first switch, the second switch, and the third switch are turned on or off.

### CROSS-REFERENCE TO RELATED APPLICATION(S)

This application claims the priority benefit of Korean Patent Application No. 10-2017-0144236 filed on Oct. 31, 2017, in the Korean Intellectual Property Office, the disclosure of which is incorporated herein by reference for all purposes.

### BACKGROUND

### 1. Field

One or more example embodiments relate to wireless power transfer, and more particularly, to a wireless power receiving apparatus configured to control an output voltage when wirelessly receiving power.

### 2. Description of Related Art

A wireless power transfer technology refers to a technology for transferring power without using electrical wires. The wireless power transfer technology uses various methods to wirelessly transfer power, for example, using electromagnetic waves, magnetic induction, magnetic resonance, electrical resonance, and the like.

As the wireless power transfer technology advances further, a single wireless power transmitting apparatus may charge a plurality of wireless power receiving apparatuses simultaneously. When the wireless power receiving apparatuses have different coupling coefficients, the wireless power receiving apparatuses may also have different output voltages.

Such a difference in output voltage due to the difference in coupling coefficient may prevent some of the wireless power receiving apparatuses from normally operating. For example, a sufficient voltage may not be supplied to a load due to a small output voltage, or a fault or a failure may occur due to an overvoltage that may be caused by a large output voltage. Thus, there is a desire for a technology for controlling an output voltage of a wireless power receiving apparatus.

### SUMMARY

An aspect provides a wireless power receiving apparatus of which an output voltage is adjusted when an operation mode thereof is determined based on whether a plurality of switches is turned on or off.

Another aspect also provides a wireless power receiving apparatus configured to operate in one of an operation mode in which an output voltage thereof increases, an operation mode in which the output voltage is maintained constantly, and an operation mode in which the output voltage decreases, when a path of a current changes based on whether a plurality of switches is turned on or off.

According to an example embodiment, there is provided a wireless power receiving apparatus including a first rectifier to which a first coil receiving power from a wireless power transmitting apparatus and a first capacitor are connected, a second rectifier to which a second coil receiving power from the wireless power transmitting apparatus and a second capacitor are connected, a first switch connected to one end of the first rectifier, and a second switch and a third switch connected to both ends of the second rectifier. The first rectifier and the second rectifier may be connected in parallel, and an operation mode of the wireless power receiving apparatus may be determined differently based on whether the first switch, the second switch, and the third switch are turned on or off.

Each of the first switch, the second switch, and the third switch may include a metal-oxide-semiconductor field-effect transistor (MOSFET) and a diode connected in parallel to the MOSFET.

When the first switch is turned off and the second switch and the third switch are turned on, the operation mode may be determined to be a boost mode.

The boost mode may be an operation mode in which a loop is formed by a current flowing in the second rectifier, and an inductance of the second coil increases by a current of the formed loop.

When the first switch and the second switch are turned on and the third switch is turned off, the operation mode may be determined to be a normal mode.

The normal mode may be an operation model in which the first switch and the second switch operate as a conducting wire, and the third switch operates as a diode.

When the first switch, the second switch, and the third switch are all turned off, the operation mode may be determined to be a half mode.

The half mode may be an operation model in which the first switch, the second switch, and the third switch all operate as a diode.

According to another example embodiment, there is provided a wireless power receiving apparatus including a first coil and a second coil configured to receive power from a wireless power transmitting apparatus. The first coil may be wound N times and the second coil may be wound M times. The first coil may be located inside the second coil, relative to a center of a same circle formed by the first coil and the second coil.

A first switch may be connected to one end of the first coil, and a second switch and a third switch may be connected to both ends of the second coil.

Each of the first switch, the second switch, and the third switch may include a MOSFET and a diode connected in parallel to the MOSFET.

The wireless power receiving apparatus may further include a first rectifier connected to both ends of the first coil and a second rectifier connected to both ends of the second coil. The first rectifier and the second rectifier may be connected in parallel.

An operation mode of the wireless power receiving apparatus may be determined based on whether the first switch, the second switch, and the third switch are turned on or off.

According to example embodiments described herein, an operation mode of a wireless power receiving apparatus may be determined based on whether a plurality of switches is turned on or off, and an output voltage of the wireless power receiving apparatus may be adjusted based on the determined operation mode.

According to example embodiments described herein, a current path may be changed based on whether a plurality of switches are turned on or off, and a wireless power receiving apparatus may operate in one of an operation mode in which an output voltage of the wireless power receiving apparatus increases, an operation mode in which the output voltage is maintained constantly, and an operation mode in which the output voltage decreases.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a block diagram illustrating an example of a wireless power receiving apparatus according to an example embodiment;

FIG. 2 is a schematic diagram illustrating an example of a circuit of a wireless power receiving apparatus according to an example embodiment;

FIG. 3 is a schematic diagram illustrating an example of a wireless power receiving apparatus operating in a boost mode according to an example embodiment;

FIG. 4 is a diagram illustrating an example of an output voltage of a wireless power receiving apparatus operating in a boost mode according to an example embodiment;

FIG. 5 is a schematic diagram illustrating an example of a wireless power receiving apparatus operating in a half mode according to an example embodiment;

FIG. 6 is a diagram illustrating an example of an output voltage of a wireless power receiving apparatus operating in a half mode according to an example embodiment;

FIG. 7 is a schematic diagram illustrating an example of a wireless power receiving apparatus operating in a normal mode according to an example embodiment; and

FIG. 8 is a diagram illustrating an example of a first coil and a second coil according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

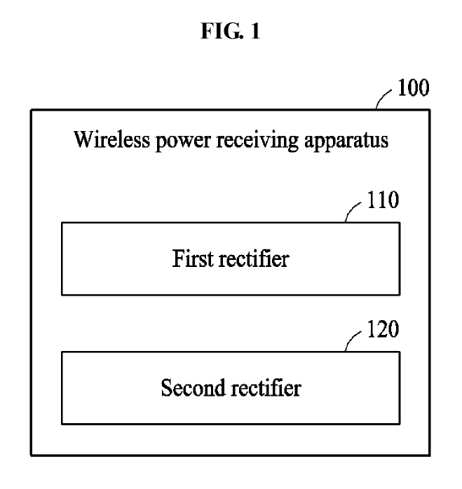

FIG. 1 is a block diagram illustrating an example of a wireless power receiving apparatus according to an example embodiment.

Referring to FIG. 1, a wireless power receiving apparatus 100 includes a first rectifier 110 and a second rectifier 120. The wireless power receiving apparatus 100 may wirelessly receive power from a wireless power transmitting apparatus (not shown).

The wireless power receiving apparatus 100 may include all types of portable electronic devices, for example, a keyboard, a mouse, and an auxiliary image or voice output device. The wireless power receiving apparatus 100 may be, for example, a wirelessly chargeable electronic device, such as, for example, a smartphone, a smart pad, a camera, and the like.

The wireless power receiving apparatus 100 includes the first rectifier 110 and the second rectifier 120 that may convert an alternating current (AC) to a direct current (DC). The first rectifier 110 and the second rectifier 120 may include a plurality of diodes and a plurality of switches. The first rectifier 110 and the second rectifier 120 may be connected in parallel to a load. The load may receive a current, a voltage, or power from the first rectifier 110 and the second rectifier 120.

To the first rectifier 110, a first coil configured to receive power from the wireless power transmitting apparatus and a first capacitor may be connected. That is, the first rectifier 110 may convert an AC flowing in the first coil to a DC.

To the second rectifier 120, a second coil configured to receive power from the wireless power transmitting apparatus and a second capacitor may be connected. That is, the second rectifier 120 may convert an AC flowing in the second coil to a DC.

The wireless power receiving apparatus 100 also includes a first switch connected to one end of the first rectifier 110. The first switch may include a metal-oxide-semiconductor field-effect transistor (MOSFET) and a diode connected in parallel to the MOSFET. The diode connected in parallel may be a body diode of the MOSFET. In addition, the first switch may be connected to a conducting wire connected to the ground among conducting wires of the first rectifier 110.

The wireless power receiving apparatus 100 also include a second switch and a third switch connected to both ends of the second rectifier 120. Each of the second switch and the third switch may include a MOSFET and a diode connected in parallel to the MOSFET. The diode connected in parallel may be a body diode of the MOSFET. In addition, the second switch and the third switch may be connected to respective two conducting wires of the second rectifier 120 connected to the ground.

Herein, based on whether the first switch, the second switch, and the third switch are turned on or off, a current flow or an inductance of each of the first rectifier 110 and the second rectifier 120 may change. In response to a change in current flow or inductance, an output voltage of each of the first rectifier 110 and the second rectifier 120 may also change. That is, based on whether the first switch, the second switch, and the third switch are turned on or off, an operation mode of the wireless power receiving apparatus 100 may be differently determined. The operation mode refers to a mode indicating how the wireless power receiving apparatus 100 operates based on an output voltage of the wireless power receiving apparatus 100.

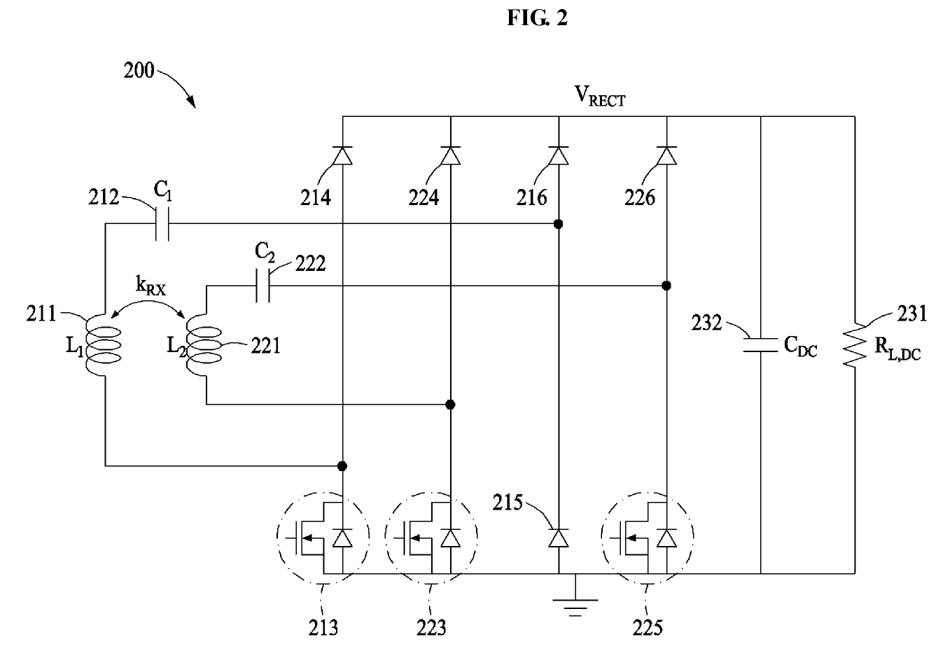

FIG. 2 is a schematic diagram illustrating an example of a circuit of a wireless power receiving apparatus according to an example embodiment.

FIG. 2 illustrates a circuit 200 of the wireless power receiving apparatus 100 of FIG. 1. Referring to FIG. 2, the circuit 200 includes a first coil 211, a first capacitor 212, a first switch 213, a plurality of diodes 214, 215, and 216, a second coil 221, a second capacitor 222, a second switch 223, a third switch 225, a plurality of diodes 224 and 226, a load 231, and a load capacitor 232.

The first coil 211 and the first capacitor 212 are connected to the first rectifier 110. The first rectifier 110 includes the first switch 213 and the diodes 214, 215, and 216. The first rectifier 110 may provide the load 231 and the load capacitor 232 with power received from the first coil 211. That is, the first rectifier 110 may provide a DC to the load 231. The load capacitor 232 may reduce a ripple of a voltage V_{RECT}, which indicates an output voltage of a rectifier.

The second coil 221 and the second capacitor 222 are connected to the second rectifier 120. The second rectifier 120 includes the second switch 223, the third switch 225, and the diodes 224 and 226. The second rectifier 120 may provide the load 231 and the load capacitor 232 with power received from the second coil 221. The second rectifier 120 is connected in parallel to the first rectifier 110 as illustrated in FIG. 2.

The load 231 and the load capacitor 232 may receive power that is wirelessly received. The load capacitor 232 may reduce the ripple of the voltage V_{RECT}. That is, the voltage V_{RECT} indicates a voltage to be transferred to the load 231 and the load capacitor 232.

An effective permeability of the wireless power receiving apparatus 100 may be represented by Equation 1 based on the circuit 200 of FIG. 2.

$$μ = 1 + \frac{{k}_{RX}^{2}}{\frac{{ω}_{2}^{2}}{{ω}^{2}} - 1} \qquad [ Equation 1 ]$$

In Equation 1, μ and k_{RX} denote an effective permeability and a coupling coefficient, respectively. ω₂ denotes a resonant frequency, wherein ω denotes an operating frequency of the wireless power receiving apparatus 100.

The effective permeability μ may be determined based on the resonant frequency ω₂. This is because a current flowing in the second coil 221 may be determined by the effective permeability μ, and an inductance L₂ of the second coil 221 may thus change.

Herein, the coupling coefficient k refers to a coupling coefficient between the first coil 211 and the second coil 221 that is generated when the wireless power receiving apparatus 100 receives power from a wireless power transmitting apparatus (not shown).

The resonant frequency ω₂ refers to a resonant frequency of the second coil 221 and the second capacitor 222. The resonant frequency ω₂ may be determined by the inductance L₂ of the second coil 221 and a capacitance C₂ of the second capacitor 222. That is, ω₂=1/\sqrt{L₂C₂}.

Herein, ω₁ denotes a resonant frequency of the first coil 211 and the first capacitor 212. As described above with reference to the resonant frequency ω₂ of the second coil 221, or also referred to as a second resonant frequency, the resonant frequency ω₁ may be determined by an inductance L₁ of the first coil 211 and a capacitance C₁ of the first capacitor 212. That is, ω₁=1/\sqrt{L₁C₁}.

The resonant frequency ω₁ of the first coil 211 and the first capacitor 212 may be adjusted to be ω₁=\sqrt{μ}ω. Herein, the adjusting of the resonant frequency 107 ₁ may induce resonance of the first coil 211 and the second coil 221, which are receiving coils.

Each of the first switch 213, the second switch 223, and the third switch 225 may include a MOSFET and a diode connected in parallel to the MOSFET. Herein, the diode may be a body diode of the MOSFET. Based on whether a corresponding MOSFET is turned on or off, a corresponding one of the first switch 213, the second switch 223, and the third switch 225 may be tuned on or off.

For example, when a MOSFET is turned off, a corresponding one of the switches 213, 223, and 225 may operate as a diode. Conversely, when a MOSFET is turned on, a corresponding one of the switches 213, 223, and 225 may operate as a shorted conducting wire.

An output voltage of the wireless power receiving apparatus 100 may change based on whether the first switch 213, the second switch 223, and the third switch 225 are turned on or off. In addition, an operation mode of the wireless power receiving apparatus 100 may be differently determined based on whether the first switch 213, the second switch 223, and the third switch 225 are turned on or off.

For example, when the first switch 213 is turned off and the second switch 223 and the third switch 225 are turned on, the operation mode of the wireless power receiving apparatus 100 may be determined to be a boost mode. For another example, when the first switch 213 and the second switch 223 are turned on and the third switch 225 is turned off, the operation mode of the wireless power receiving apparatus 100 may be determined to be a normal mode. For still another example, when the first switch 213, the second switch 223, and the third switch 225 are all turned off, the operation mode of the wireless power receiving apparatus 100 may be determined to be a half mode.

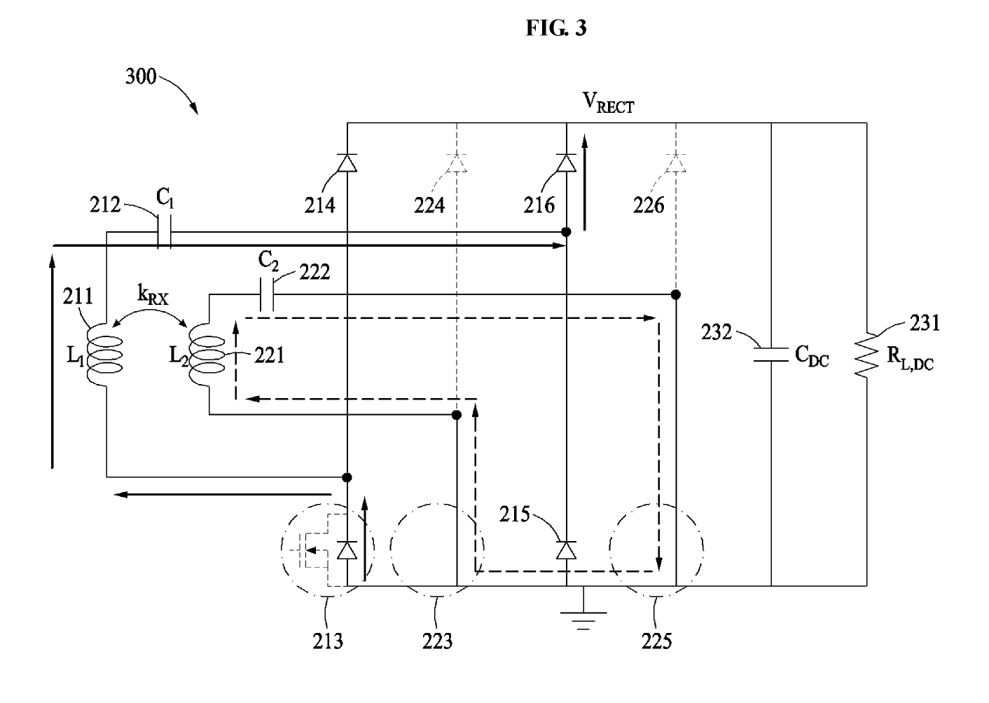

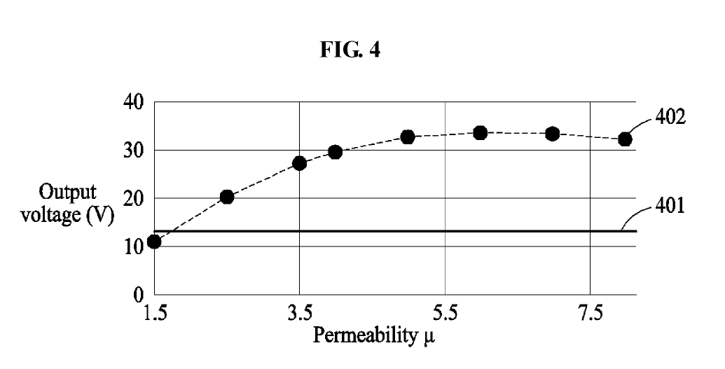

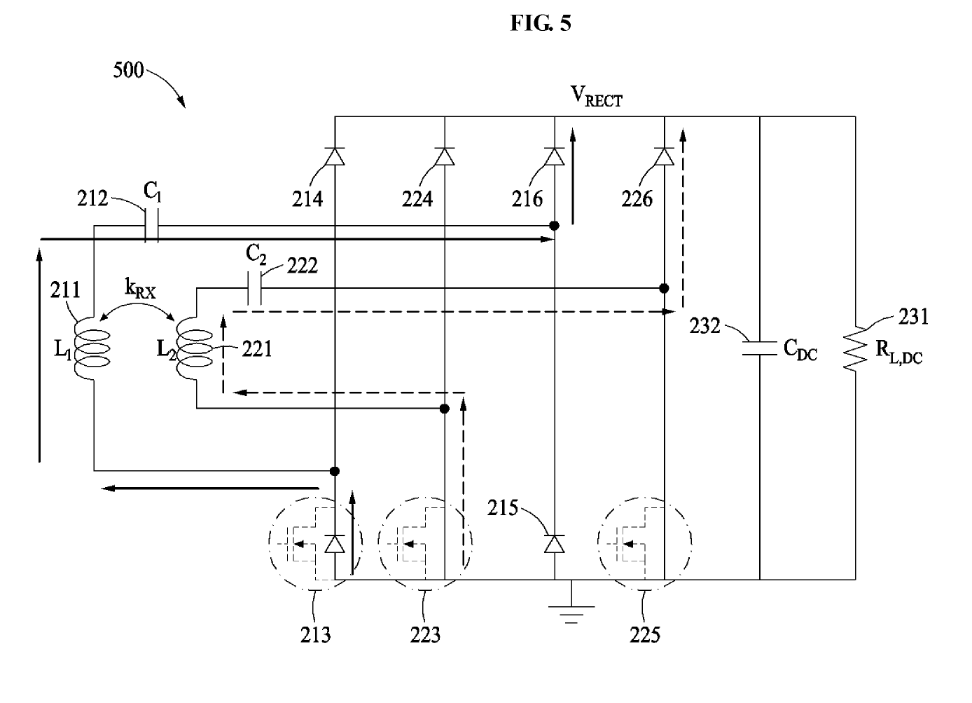

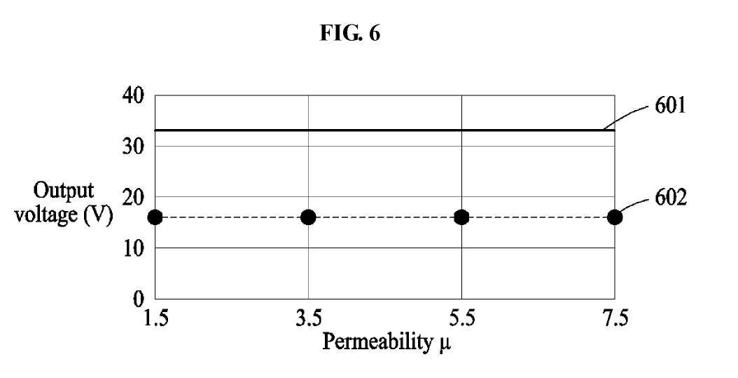

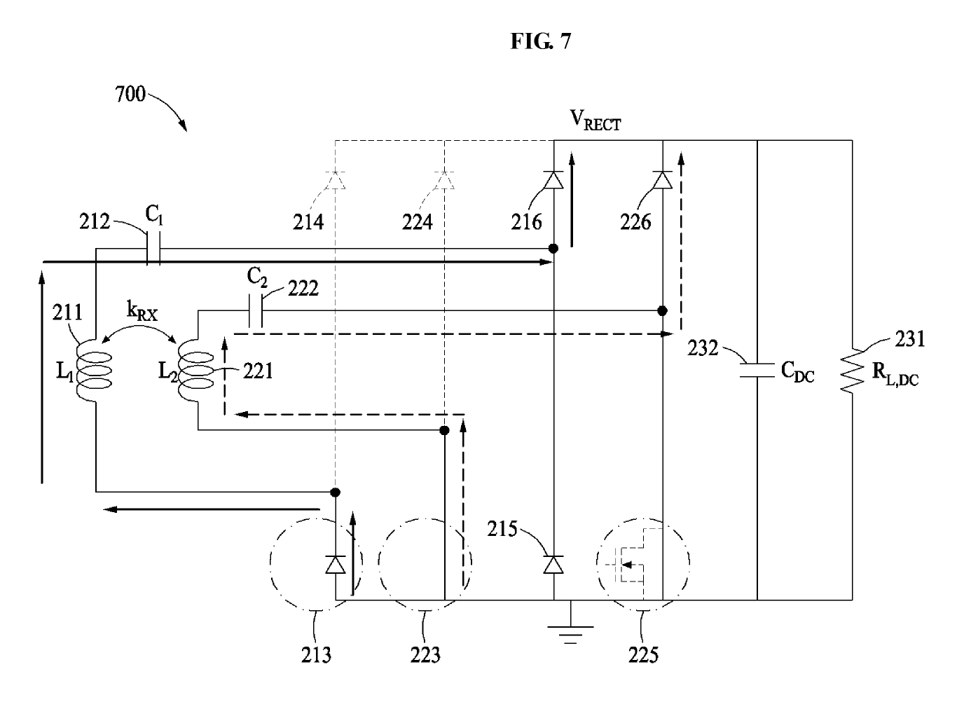

The wireless power receiving apparatus 100 operating in the boost mode will be described in detail with reference to FIGS. 3 and 4. The wireless power receiving apparatus 100 operating in the half mode will be described in detail with reference to FIGS. 5 and 6. The wireless power receiving apparatus 100 operating in the normal mode will be described in detail with reference to FIG. 7.

FIG. 3 is a schematic diagram illustrating an example of a circuit of a wireless power receiving apparatus operating in a boost mode according to an example embodiment.

FIG. 3 illustrates a circuit 300 of the wireless power receiving apparatus 100 that operates in a boost mode.

The boost mode refers to an operation mode in which the first switch 213 is turned off and the second switch 223 and the third switch 225 are turned on. Referring to FIG. 3, the first switch 213 that is turned off may operate as a diode, and the second switch 223 and the third switch 225 that are turned on may operate as a conducting wire.

When the second switch 223 and the third switch 225 are turned on, a current flowing in the second coil 221 may form a loop. That is, the current flowing in the second coil 221 may not flow towards the diodes 224 and 226, but form the loop while passing the second switch 223 and the third switch 225.

Due to the formed loop, the current flowing in the second coil 221 may affect a current flowing in the first coil 211. In other words, the current flowing in the second coil 221 may change an inductance of the current flowing in the first coil 211. For example, when the current flows in the second coil 221, an impedance on a side of the first coil 211 mutually coupled with the second coil 221 may change, and the inductance may thus change.

Herein, when a resonant frequency of the second coil 221 and the second capacitor 222 is adjusted, an amount of the change in the inductance of the current flowing in the first coil 211 may also be adjusted. For example, when at least one of an inductance L₂ of the second coil 221 or a capacitance C₂ of the second capacitor 222 is adjusted, the amount of the change in the inductance of the current flowing in the first coil 211 may also be adjusted, and an increased amount of an output voltage may thus be adjusted.

In a case in which the wireless power receiving apparatus 100 is separated far from a wireless power transmitting apparatus (not shown), allowing the wireless power receiving apparatus 100 to operate in the boost mode may help effectively increase an output voltage of the wireless power receiving apparatus 100. Also, in a case in which the wireless power receiving apparatus 100 has a coupling coefficient lower than that of another wireless power receiving apparatus (not shown) that is charged along with the wireless power receiving apparatus 100, allowing the wireless power receiving apparatus 100 to operate in the boost mode may help effectively increase the output voltage thereof.

In detail, when an effective permeability μ increases, an output voltage V_{RECT} may also increase. An output voltage of the wireless power receiving apparatus 100 operating in the boost mode is illustrated in FIG. 4 with respect to an effective permeability.

FIG. 4 is a diagram illustrating an example of an output voltage of a wireless power receiving apparatus operating in a boost mode according to an example embodiment.

FIG. 4 illustrates an output voltage 402 of the circuit 300 illustrated in FIG. 3, and an output voltage 401 of a wireless power receiving apparatus (not shown) including a single coil. In the example illustrated in FIG. 4, the output voltage 402 may be an output voltage under the conditions that a distance is 6.5 centimeters (cm), and L₁ is 5 and L₂ is 5.

The wireless power receiving apparatus used herein may include the single coil having an inductance corresponding to that of a coil of the first coil 211 and the second coil 221 being connected to each other in series. For example, the first coil 211 and the second coil 221 may be wound inward and outward relative to a center of a same circle formed by the first coil 211 and the second coil 221, and thus the single coil may be a coil connecting the first coil 211 and the second coil 221.

Referring to FIG. 4, it is verified, based on the output voltage 401, that a constant voltage is output despite a change in effective permeability μ. That is, the wireless power receiving apparatus including the single coil may provide a load with a constant voltage irrespective of an effective permeability.

In contrast, it is verified, based on the output voltage 402, that an output voltage increases when an effective permeability μ increases. That is, it is verified that an output voltage of the wireless power receiving apparatus 100 increases based on an effective permeability of the wireless power receiving apparatus 100 operating in the boost mode. In addition, it is also verified that, by comparing the output voltage 401 and the output voltage 402, an output voltage varies approximately by two times based on an effective permeability μ.

FIG. 5 is a schematic diagram illustrating an example of a circuit of a wireless power receiving apparatus operating in a half mode according to an example embodiment.

FIG. 5 illustrates a circuit 500 of the wireless power receiving apparatus 100 that operates in a half mode.

The half mode refers to an operation mode in which the first switch 213, the second switch 223, and the third switch 225 are all tuned off. Referring to FIG. 5, the first switch 213, the second switch 223, and the third switch 225 that are turned off may operate as a diode.

In the circuit 500, a current flowing in the first coil 211 may flow to the diode 216 through the first switch 213, and a current flowing in the second coil 221 may flow to the diode 226 through the second switch 223.

In the wireless power receiving apparatus 100 operating in the half mode, each of the first coil 211 and the second coil 221 may receive about half of power received from a wireless power transmitting apparatus (not shown). Thus, an output voltage may be reduced by half, compared to when a single coil is used to receive the power. This is because a length of a coil is halved, and an induced voltage is also reduced by half.

Thus, in a case in which the wireless power receiving apparatus 100 is close to the wireless power transmitting apparatus, allowing the wireless power receiving apparatus 100 to operate in the half mode may help reduce an output voltage thereof, and it is thus possible to prevent a fault or a failure that may be caused by an overvoltage. Also, in a case in which the wireless power receiving apparatus 100 has a coupling coefficient greater than that of another wireless power receiving apparatus (not shown) that is charged along with the wireless power receiving apparatus 100, allowing the wireless power receiving apparatus 100 to operate in the half mode may help reduce an output voltage thereof, and thus the other wireless power receiving apparatus may also receive power effectively.

The wireless power receiving apparatus 100 operating in such a half mode may output a constant voltage irrespective of an effective permeability μ. An output voltage of the wireless power receiving apparatus 100 operating in the half mode is illustrated in FIG. 6 with respect to an effective permeability.

FIG. 6 is a diagram illustrating an example of an output voltage of a wireless power receiving apparatus operating in a half mode according to an example embodiment.

FIG. 6 illustrates an output voltage 602 of the circuit 500 illustrated in FIG. 5, and an output voltage 601 of a wireless power receiving apparatus (not shown) including a single coil. In the example illustrated in FIG. 6, the wireless power receiving apparatus that outputs the output voltage 601 is the same as the wireless power receiving apparatus that outputs the output voltage 401 illustrated in FIG. 4. In the example illustrated in FIG. 6, a distance between coils is 2 cm and the number of turns is 5 turns.

Referring to FIG. 6, it is verified, based on the output voltage 601, that a constant voltage is output irrespective of an effective permeability μ. That is, the wireless power receiving apparatus including the single coil may provide a load with a constant voltage irrespective of an effective permeability.

It is also verified, based on the output voltage 602, that a constant voltage is output irrespective of an effective permeability μ. That is, the wireless power receiving apparatus 100 operating in the half mode may provide a load with a constant voltage irrespective of an effective permeability. It is also verified, by comparing the output voltage 601 and the output voltage 602, that the output voltage 602 is about half of the output voltage 601.

FIG. 7 is a schematic diagram illustrating an example of a circuit of a wireless power receiving apparatus operating in a normal mode according to an example embodiment.

FIG. 7 illustrates a circuit 700 of the wireless power receiving apparatus 100 operating in a normal mode.

The normal mode refers to an operation mode in which the first switch 213 and the second switch 223 are turned on and the third switch 225 is turned off. Referring to FIG. 7, the first switch 213 and the second switch 223 that are turned on may operate as a conducting wire, and the third switch 225 that is turned off may operate as a diode.

In the circuit 700, a current flowing in the first coil 211 may flow to the diode 216 through the first switch 213, and a current flowing in the second coil 221 may flow to the diode 226 through the second switch 223, as shown in the circuit 500 illustrated in FIG. 5.

As both the first switch 213 and the second switch 223 operate as a conducting wire, each of the first rectifier 110 and the second rectifier 120 may operate similarly to a half-bridge rectifier. Thus, an output voltage to be supplied to the load 231 may be similar to one that is obtained when power is received through a single coil.

Thus, in a case in which the wireless power receiving apparatus 100 is located from a wireless power transmitting apparatus (not shown) by a desirable distance therebetween, allowing the wireless power receiving apparatus 100 to operate in the normal mode may help maintain a desirable output voltage. Also, in a case in which the wireless power receiving apparatus 100 has a coupling coefficient similar to that of another wireless power receiving apparatus (not shown) that is charged along with the wireless power receiving apparatus 100, allowing the wireless power receiving apparatus 100 to operate in the normal mode may enable both the two wireless power receiving apparatuses to receive power effectively.

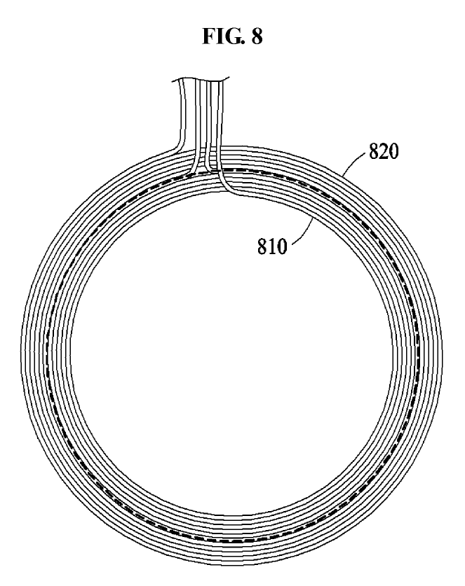

FIG. 8 is a diagram illustrating an example of a first coil and a second coil according to an example embodiment.

FIG. 8 illustrates a first coil 810 and a second coil 820. Both the first coil 810 and the second coil 820 may be included in the wireless power receiving apparatus 100.

Referring to FIG. 8, the first coil 810 may be wound N times and the second coil 820 may be wound M times, wherein each of N and M denotes an integer that is not 0 and indicates the number of turns of a corresponding coil. The first coil 810 and the second coil 820 may be wound in a circular form with a center shared by both the first coil 810 and the second coil 820. Alternatively, the first coil 810 and the second coil 820 may be wound in a rectangular form with a center shared by the both. Although the first coil 810 and the second coil 820 are illustrated as being wound in the circular form, examples are not limited to the illustrated example and the first coil 810 and the second coil 820 may be wound in various forms with a center shared by the both.

The first coil 810 may be located inside the second coil 820, relative to a center of a circle formed by both the first coil 810 and the second coil 820. Alternatively, locations of the first coil 810 and the second coil 820 may change to each other. That is, the first coil 810 may be located outside the second coil 820, relative to the center of the circle.

The first coil 810 and the second coil 820 may be located inside and/or outside at a same height, and also at different heights. That is, the heights of the first coil 810 and the second coil 820 may not be fixed, but changeable.

A single conducting wire is extended from each of both ends of each of the first coil 810 and the second coil 820. Herein, the first switch 213 may be connected to one end of the first coil 810, and the second switch 223 and the third switch 225 may be connected to both ends of the second coil 820.

The first switch 213, the second switch 223, and the third switch 225 may all be connected to the ground. Each of the first switch 213, the second switch 223, and the third switch 225 may include a MOSFET and a diode connected in parallel to the MOSFET.

Herein, the first switch 213, along with a plurality of diodes, may be included in the first rectifier 110. The both ends of the first coil 810 connected to the first switch 213 may be connected to the first rectifier 110. In addition, the second switch 223 and the third switch 225, along with a plurality of diodes, may be included in the second rectifier 120. The both ends of the second coil 820 connected to the second switch 223 may be connected to the second rectifier 120.

A path of a current flowing in the first coil 810 and the second coil 820 may change based on whether the first switch 213, the second switch 223, and the third switch 225 are turned on or off. When the path of the current changes, an operation mode of the wireless power receiving apparatus 100 may be determined based on the changed path. The operation mode may include the boost mode, the normal mode, and the half mode that are described herein with reference to FIGS. 2 through 7.

The components described in the example embodiments of the present disclosure may be achieved by hardware components including at least one of a digital signal processor (DSP), a processor, a controller, an application specific integrated circuit (ASIC), a programmable logic element such as a field programmable gate array (FPGA), other electronic devices, and combinations thereof. At least some of the functions or the processes described in the example embodiments of the present disclosure may be achieved by software, and the software may be recorded on a recording medium. The components, the functions, and the processes described in the example embodiments of the present disclosure may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless power receiving apparatus comprising:
a first rectifier to which a first coil receiving power from a wireless power transmitting apparatus and a first capacitor are connected;
a second rectifier to which a second coil receiving power from the wireless power transmitting apparatus and a second capacitor are connected;
a first switch connected to one end of the first rectifier; and
a second switch and a third switch connected to both ends of the second rectifier,
wherein the first rectifier and the second rectifier are connected in parallel, and
an operation mode of the wireless power receiving apparatus is determined differently based on whether the first switch, the second switch, and the third switch are turned on or off.

2. The wireless power receiving apparatus of claim 1, wherein each of the first switch, the second switch, and the third switch includes a metal-oxide-semiconductor field-effect transistor (MOSFET) and a diode connected in parallel to the MOSFET.

3. The wireless power receiving apparatus of claim 1, wherein, when the first switch is turned off and the second switch and the third switch are turned on, the operation mode is determined to be a boost mode.

4. The wireless power receiving apparatus of claim 3, wherein the boost mode is an operation mode in which a loop is formed by a current flowing in the second rectifier, and an inductance of the second coil increases by a current of the formed loop.

5. The wireless power receiving apparatus of claim 1, wherein, when the first switch and the second switch are turned on and the third switch is turned off, the operation mode is determined to be a normal mode.

6. The wireless power receiving apparatus of claim 5, wherein the normal mode is an operation model in which the first switch and the second switch operate as a conducting wire, and the third switch operates as a diode.

7. The wireless power receiving apparatus of claim 1, wherein, when the first switch, the second switch, and the third switch are all turned off, the operation mode is determined to be a half mode.

8. The wireless power receiving apparatus of claim 7, wherein the half mode is an operation model in which the first switch, the second switch, and the third switch all operate as a diode.

9. A wireless power receiving apparatus comprising:
a first coil and a second coil configured to receive power from a wireless power transmitting apparatus,
wherein the first coil is wound N times and the second coil is wound M times, and
the first coil is located inside the second coil, relative to a center of a same circle formed by the coils.

10. The wireless power receiving apparatus of claim 9, wherein a first switch is connected to one end of the first coil, and
a second switch and a third switch are connected to both ends of the second coil.

11. The wireless power receiving apparatus of claim 10, wherein each of the first switch, the second switch, and the third switch includes a metal-oxide-semiconductor field-effect transistor (MOSFET) and a diode connected in parallel to the MOSFET.

12. The wireless power receiving apparatus of claim 9, further comprising:
a first rectifier connected to both ends of the first coil; and
a second rectifier connected to both ends of the second coil,
wherein the first rectifier and the second rectifier are connected in parallel.

13. The wireless power receiving apparatus of claim 9, wherein an operation mode of the wireless power receiving apparatus is determined based on whether the first switch, the second switch, and the third switch are turned on or off.
